(19) United States
(12) Patent Application Publication
(10) Pub. No.: US 2021/0073216 A1
(43) Pub. Date: Mar. 11, 2021

(54) BUSINESS INTELLIGENCE SYSTEM BASED ON ARTIFICIAL INTELLIGENCE AND ANALYSIS METHOD THEREOF

(71) Applicant: Synergies Intelligent Systems, Inc. Taiwan Branch, Taipei (TW)

(72) Inventor: Tsung-Yao Chang, Taipei (TW)

(21) Appl. No.: 16/940,459

(22) Filed: Jul. 28, 2020

Related U.S. Application Data
(60) Provisional application No. 62/896,066, filed on Sep. 5, 2019.

(51) Int. Cl. G06F 16/242; G06F 16/215; G06F 16/2457; G06F 16/248; G06F 16/26; G06F 16/28; G06F 16/25

(52) U.S. Cl. CPC G06F 16/243; G06F 16/215; G06F 16/24573; G06F 16/254; G06F 16/26; G06F 16/283; G06F 16/248

(57) ABSTRACT

A business intelligence system based on artificial intelligence includes a search engine configured to receive natural language and disassemble relevant words in the natural language; an AI analysis module configured to analyze the relevant words to obtain a data extraction grammar; a feature extraction module configured to extract multiple feature data from multiple databases corresponding to the data extraction grammar; and a data manager configured to process the multiple feature data and present the multiple feature data to the user. The system has a function of natural language response, and can quickly and efficiently analyze the user's intention to extract and analyze the correlation data to assist the user to make more accurate decisions.

### FIELD OF THE INVENTION

The present invention relates to a business intelligence system, and more particularly to a business intelligence system and an analysis method based on artificial intelligence.

### BACKGROUND OF THE INVENTION

Business Intelligence (BI) is widely applied to enterprises with a variety of systems and databases. It can provide functions such as data analysis, data mining, data search, database stringing, reporting, performance measurement, bookkeeping and charting. One or more BI applications can work at the same time to provide a BI system with a wide range of functions.

A traditional BI system 100 is shown in FIG. 1. The key to the establishment of the BI system is to collect and clean up the data from many operating systems of different organizations to ensure the correctness of the data. Then, the data is processed by multiple extractions, transformations and loads, namely ETL process, and Operation Data Store (ODS), and then merged into an enterprise Data Warehouse (DW) and/or Data Mart, accordingly an overall view of the enterprise data can be obtained, on the basis of which, the data can be analyzed and processed by using appropriate query and analysis tools, Data Mining tools, on-line analytical processing (OLAP) tools and so on, finally the analysis results are presented to managers, thereby providing support for the managerial decision-making process.

However, this traditional BI system has the following drawbacks:

The operating surface of the existing BI system requires IT staff to establish search conditions in computer language in advance, and the condition setting is rigid, which must be limited to specific conditions to lead a successful search. Moreover, the data retrieval process for the connected system (such as ERP) is in single dimension linear form, which makes it impossible to independently judge related data and link them horizontally.

Due to the fact that the settings of the existing BI system require manual operation, it is impossible for users to conduct in-depth multi-dimensional analysis, let alone make comprehensive cross-oriented decisions.

Therefore, it is urgent to provide a BI system combining artificial intelligence (AI) to overcome the above drawbacks.

### SUMMARY OF THE INVENTION

Objectives of the present invention is to provide a business intelligence system and an analysis method based on AI, which has the function of natural language response, and can quickly and efficiently analyze the user's intention to extract and analyze the correlation data to assist the user to make more accurate decisions.

To achieve the above-mentioned objectives, a business intelligence system based on artificial intelligence (AI) includes:

a search engine, configured to receive natural language of a user and disassemble relevant words in the natural language;

an AI analysis module, configured to analyze the relevant words to obtain a data extraction grammar;

a feature extraction module, configured to extract multiple feature data from multiple databases corresponding to the data extraction grammar; and

a data manager, configured to process the multiple feature data and present the multiple feature data to the user.

Preferably, the AI analysis module is configured to extract multiple word functions from multi sentence grouping databases that are pre-established, and compare the relevant words with the word functions to determine the data extraction grammar.

Preferably, the AI analysis module is further configured to extract data forms, fields, schemas from the multiple feature databases, and create the word functions by cross-dimensional integration and depth feature extraction.

Preferably, the AI analysis module is further configured to classify the multiple relevant words that are associated.

Preferably, the AI analysis module is further configured to feed back the multiple relevant words that are associated to the user.

Preferably, the feature extraction module comprises a virtual data set, a data connection module for data connection between multiple database tables, a data tagging module for tagging data, and a feature extraction unit.

Preferably, the data manager is configured to perform integration, grouping, disassembly, prediction, association, and tagging to the multiple feature data.

Preferably, the data manager comprises a data cleaning module for checking and correcting the multiple feature data and removing repeated data, an index module for indexing the multiple feature data according to predetermined rules, and an ETL processing module for performing ETL process to the multiple feature data.

Preferably, the system further includes a user interface adapted for allowing the user to input the natural language and present at least one of charts, text and data.

Preferably, the system further includes a retraining module connected with the AI analysis module and adapted for recording operation history of the user and updating the multiple feature databases.

An analysis method based on artificial intelligence (AI) of the present invention includes:

searching and analyzing relevant words in natural language of a user, and obtaining a data extraction grammar that is associated with the relevant words;

extracting multiple feature data from multiple databases corresponding to the data extraction grammar; and

processing and presenting the multiple feature data.

Preferably, said searching and analyzing relevant words in user's natural language, and obtaining a data extraction grammar that is associated with the relevant words includes:

disassembling the natural language into multiple relevant words;

extracting multiple word functions from multiple grouping databases that are pre-established; and

comparing the relevant words with the word functions to determine the data extraction grammar.

Preferably, said extracting multiple word functions from multiple grouping databases that are pre-established includes: extracting data forms, fields, schemas from the multiple feature databases and creating the word functions by cross-dimensional integration and depth feature extraction.

Preferably, the method further includes classifying the relevant words that are associated.

Preferably, the method further includes feeding back the relevant words that are associated to the user.

Preferably, said extracting multiple feature data from multiple databases corresponding to the data extraction grammar includes:

establishing a virtual data set;

establishing multiple database tables for data connection;

tagging different data; and

extracting the feature data.

Preferably, said processing the multiple feature data includes:

checking and correcting the multiple feature data and removing repeated data;

indexing the multiple feature data according to predetermined rules; and

performing ETL process to the multiple feature data.

Preferably, said presenting the multiple feature data includes presenting at least one of charts, text and data according to user habits and data attributes.

Preferably, the method further includes recording operation history of the user and updating the multiple feature databases.

In comparison with the prior art, since the analysis method and the BI system based on AI of the present invention has a natural language response function, by which users can use simple oral sentences to query, and then the meanings of the sentences and the correlations are analyzed through mechanical learning, to find out the cross-database relevant data, and generate and present various data results to the user. Therefore, independent analysis ability is improved, to quickly assist the user to make more accurate decisions.

### BRIEF DESCRIPTION OF THE DRAWINGS

The accompanying drawings facilitate an understanding of the various embodiments of this invention. In such drawings:

FIG. 1 is a schematic view of a conventional business intelligence system;

FIG. 2 is a schematic view of a business intelligence system based on AI according to one embodiment of the present invention;

FIG. 3 is a schematic view of a business intelligence system based on AI according to another embodiment of the present invention;

FIG. 4 is a flowchart of an analysis method based on AI according to one embodiment of the present invention; and

FIG. 5 is a flowchart of an analysis method based on AI according to another embodiment of the present invention.

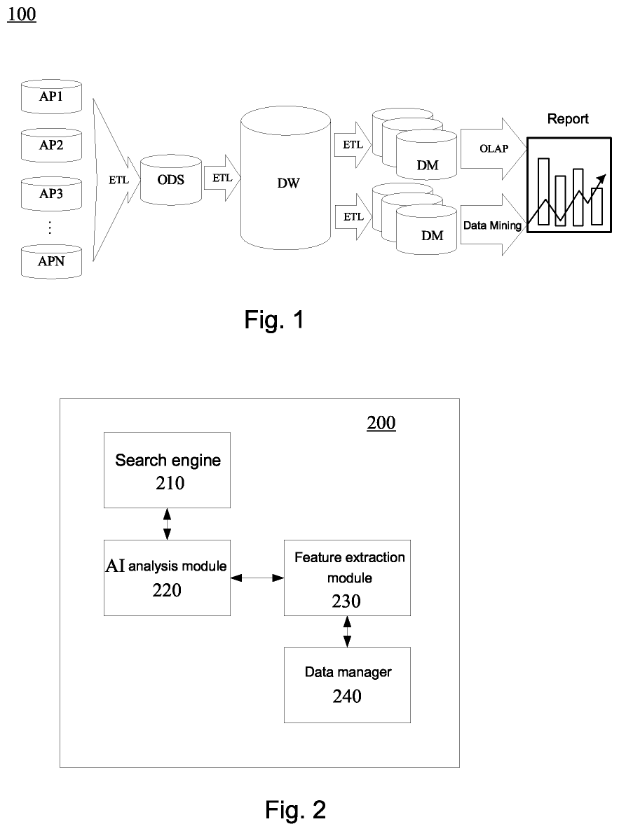

### DETAILED DESCRIPTION OF ILLUSTRATED EMBODIMENTS

A distinct and full description of the technical solution of the present invention will follow by combining with the accompanying drawings. The present invention is aimed at providing a business intelligence system and an analysis method based on AI, which is widely used in the manufacturing industry where data is difficult to be collected and in the financial industry where real-time and correct data are required, thereby providing cross-domain intelligent analysis for enterprises and solving enterprise decision-making problems.

Referring to FIG. 2, a business intelligence system 200 based on AI according to one embodiment of the present invention includes a search engine 210, an AI analysis module 220, a feature extraction module 230 and a data manager 240. Specifically, the search engine 210 is configured to receive user's natural language. The AI analysis module 220 is configured to analyze the relevant words to obtain a data extraction grammar. The feature extraction module 230 is configured to extract multiple feature data from multiple databases corresponding to the data extraction grammar. The data manager is configured to process the multiple feature data and present the multiple feature data to the user.

The Business intelligence system based on AI of the present invention has a natural language response function, by which users can use simple oral sentences to query, and then the meanings of the sentences and the correlations are analyzed by the system through mechanical learning, to find out the cross-database relevant data, and generate and present various data results to the user. Therefore, independent analysis ability is improved, to quickly assist the user to make more accurate decisions.

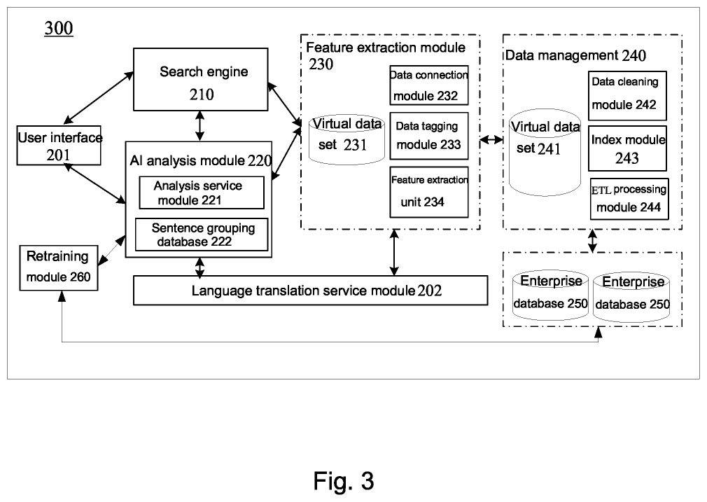

FIG. 3 a schematic view of a business intelligence system based on AI according to a preferred embodiment of the present invention. As illustrated, the business intelligence system 300 further includes a user interface 201 as a human-machine interactive interface directly operated by the user, for example, for the user to input natural language to the search engine 210 in text or voice mode, and to present the user with visual images, text, charts, lists or animated movies and other information. Specifically, the user interface 201 is configured with a display such as LCD and microphone.

The search engine 210 served as an information retrieval system is adapted for receiving the user's natural language and disassembling relevant words and sentences contained in the natural language. The search engine 210 is executed by a computer program and generally includes a searcher, an indexer, and user interface. The user interface can be the above mentioned user interface 201. For example, the user can enter the content they are looking for in text or voice. The search engine 210 uses NLP technology to disassemble the natural language through the keyword and phrasing mechanism, and sends the disassembled relevant words to the AI analysis module 220, and feeds the relevant words back to the user interface 201 for the user to choose.

Preferably, the search engine 210 can receive natural language input in Chinese or in other languages, and the language translation service module 202 can be connected. The language translation service module 202 can not only translate natural language, but also automatically translate feature data into the target language.

Specifically, the AI analysis module 220 includes an analysis service module 221. After the natural language is disassembled by the search engine 210, the analysis service module 221 is adapted for establishing a plurality of words/sentence grouping databases 222 through mechanical learning and extracting multiple word functions from the sentence grouping databases 222. The method of extracting word functions in the sentence grouping database 222 specifically includes extracting data forms, fields, and charts from multiple words/sentence grouping databases 222, and generating the word functions after cross-dimensional integration and depth feature extraction. Preferably, after receiving relevant words and sentences, the relevance between multiple relevant words and sentences is analyzed, and the relevant words and sentences that are associated are classified into one category. Then, the relevant words and sentences and word functions are compared, the data extraction grammar can be determined and generated if the relevant words and sentences are associated with the word functions, accordingly corresponding feature data can be extracted from the respective feature database.

Preferably, in the analysis service module 221 of the AI analysis module 220, a plurality of relevant words and sentences can be arranged and combined, and a plurality of interrogative sentences can be formed to feed back to the user for selection, accordingly, the feature extraction module 230 extracts the corresponding feature data.

Specifically, as shown in FIG. 3, the feature extraction module 230 includes a virtual data set 231, a data connection module 232, a data tagging module 233 and a feature extraction unit 234. The virtual data set 231 is configured to store information after feature engineering processing in order to improve the search speed. Specifically, the virtual data set 231 contains mathematical operations (such as addition, subtraction, multiplication, division, subsquare root, log, etc.) among multiple feature data, multidimensional data clustering, and unstructured data feature extraction (such as text keyword extraction). The data connection module 232 is configured to make data connection between multiple database tables in order to structure the data. Preferably, the types of data connection (JOIN) include INNER JOIN, LEFT OUTER JOIN, RIGHT OUTER JOIN and FULL OUTER JOIN. The data tagging module 233 is configured to tag data, for example, the content of the label is a keyword, or interpretable content, thereby improving recognition and user convenience. More preferably, the data tagging module 233 can communicate with the analysis service module 221 to assist in analyzing the correlation analysis of the analysis service module 221. The feature extraction unit 234 is configured to extract corresponding feature data from the corresponding feature database according to the data extraction grammar, and quickly extract feature data from a relational database using an SQL engine for example.

Referring to FIG. 3, the data manager 240 is configured to receive the feature data from the feature extraction unit 234 and perform value-added processing to the data, such as integration, grouping, disassembly, prediction, association, and tagging. Specifically, the data management 240 includes a virtual data set 241, a data cleaning module 242, an index module 243, and an ETL processing module 244. Specifically, the virtual data set 241 is configured to store the information processed by the original feature data to improve the feature recognition. The data cleansing module 242 is configured to repeatedly detect and correct the fields of each data, deal with missing values (Missing Value), remove duplicate data, etc., and ensure the quality of data cleansing by evaluating the validity, integrity, precision, and consistency of the data. As an embodiment, the data cleansing module 242 can establish a statistical distribution model for a single feature data to find outliers, and can also perform clustering calculation and outlier detection for multi-dimensional data to find out abnormal data or missing data, so as to repair the data by averaging, interpolation, and extrapolation. The index module 243 is configured to index various proper names (person names, place names, book names, article names, event names, object names), topics or words (sentences, phrases), and then sort them according to certain methods, such as strokes, alphabetical, spelling, four corner numbers or classification, and indicate the source for quick retrieval. The ETL (Extraction-Transformation-Loading) processing module 244 is configured to process data extraction, conversion and loading, and is mainly responsible for completing the process of data conversion from the data source to the target data warehouse. This ETL processing is a conventional technology in the art and will not be repeated here therefore. After the feature data is processed as described above, appropriate graphic content, styles, and overall distribution are provided on the user interface 201 according to user habits and data attributes.

Preferably, the business intelligence system 300 further includes an enterprise database 250 connected to the data manager 240 to store the processed feature data. Specifically, the enterprise database 250 is a collection that stores, organizes, and manages enterprise data according to a data structure, that is, the enterprise database 250 can be simply defined as a collection of all data that are stored together in a certain organization, have certain relevance, and is of common concern to users. The enterprise database 250 establishes a link with the data manager 240, and the data manager 240 can obtain data in real time or periodically, thereby providing desired information to the user.

As a preferred embodiment, the business intelligence system 300 further includes a retraining module 260 connected to the AI analysis module 220 to record historical operations of the user and update multiple feature databases. For example, the user's operation history and data results are recorded through the log, and the log content is retrained to the existing model in the AI analysis module 220, thereby adjusting the content to be presented and improving the accuracy. It can also be associated with the search results, the optimized presentation charts, etc., thereby continuously optimizing the user experience and information accuracy. As another embodiment, for the selection of users, the module 260 can adjust the parameters of the model through parameter optimization methods such as Backpropagation algorithm and Expectation maximization algorithm.

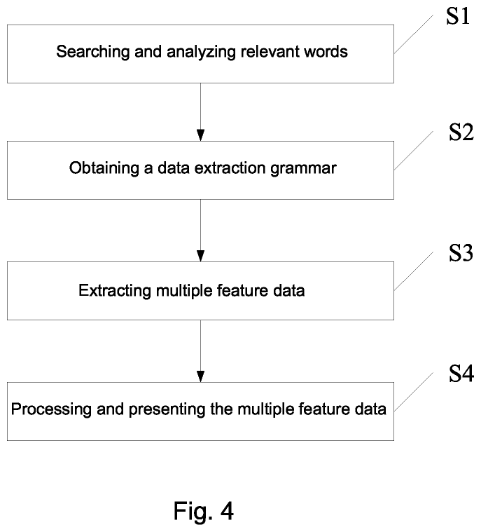

Accordingly, the analysis method based on AI according to the present invention is realized by setting up the above business intelligence system, and a flowchart according to one embodiment is shown in FIG. 4, and the method includes:

S1, searching and analyzing relevant words in user's natural language;

S2, obtaining a data extraction grammar that is associated with the relevant words;

S3, extracting multiple feature data from multiple databases corresponding to the data extraction grammar; and

S4, processing and presenting the multiple feature data.

The analysis method based on AI of the present invention has a natural language response function, by which users can use simple oral sentences to query, and then the meanings of the sentences and the correlations are analyzed through mechanical learning, to find out the cross-database relevant data, and generate and present various data results to the user. Therefore, independent analysis ability is improved, to quickly assist the user to make more accurate decisions.

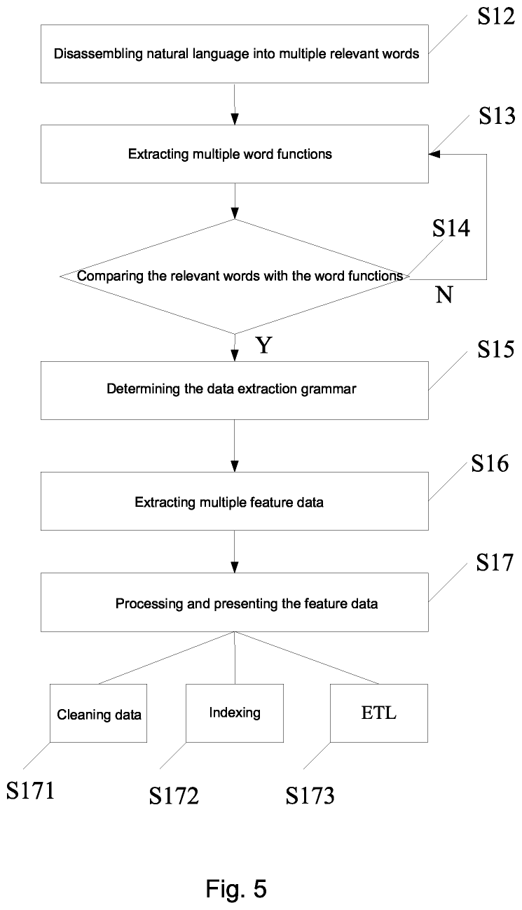

As a preferable embodiment shown in FIG. 5, the method further includes:

S12, disassembling the natural language into multiple relevant words;

S13, extracting multiple word functions from multiple grouping databases that are pre-established;

S14-S15, comparing the relevant words with the word functions to determine the data extraction grammar;

S16, extracting multiple feature data according to the data extraction grammar;

S17, processing and presenting the feature data.

Specifically, users may input natural language to the search engine 210 in text or voice manner, in Chinese, English or other languages. In the step S12, it may further include translating the natural language into a target language.

Preferably, after the natural language is disassembled, a plurality of words/sentences grouping databases 222 are establishing through mechanical learning and multiple word functions are extracted from the sentence grouping databases 222. The method of extracting word functions in the sentence grouping database 222 specifically includes extracting data forms, fields, and charts from multiple words/sentence grouping databases 222, and generating the word functions after cross-dimensional integration and depth feature extraction. Preferably, after receiving relevant words and sentences, the relevance between multiple relevant words and sentences is analyzed, and the relevant words and sentences that are associated are classified into one category. Then, the relevant words and sentences and word functions are compared, the data extraction grammar can be determined and generated if the relevant words and sentences are associated with the word functions, accordingly corresponding feature data can be extracted from the respective feature database.

More preferably, the relevant words and sentences can be arranged and combined, and a plurality of interrogative sentences can be formed to feed back to the user for selection, accordingly, the corresponding feature data can be extracted.

Preferably, the step of extracting feature data includes establishing a virtual data set; establishing multiple database tables for data connection; tagging different data; and extracting the feature data.

As shown in FIG. 5, the process to the feature data includes: performing integration, grouping, disassembly, prediction, association, tagging, and/or translation. Specifically, the steps include: S171, checking and correcting the multiple feature data and removing repeated data; S172, indexing the multiple feature data according to predetermined rules; and S173, performing ETL process to the multiple feature data. After the feature data is processed as described above, appropriate graphic content, styles, and overall distribution are provided on the user interface 201 according to user habits and data attributes.

Preferably, the analysis method further includes recording operation history of the user and updating the multiple feature databases. For example, the user's operation history and data results are recorded through the Log, and the Log content is retrained to the existing model in the AI analysis module 220, thereby adjusting the content to be presented and improving the accuracy. It can also be associated with the search results, and the optimized presentation charts, etc., thereby continuously optimizing the user experience and information accuracy.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A business intelligence system based on artificial intelligence (AI), comprising:
a search engine, configured to receive natural language of a user and disassemble relevant words in the natural language;
an AI analysis module, configured to analyze the relevant words to obtain a data extraction grammar;
a feature extraction module, configured to extract multiple feature data from multiple databases corresponding to the data extraction grammar; and
a data manager, configured to process the multiple feature data and present the multiple feature data to the user.

2. The business intelligence system based on AI according to claim 1, wherein the AI analysis module is configured to extract multiple word functions from multi sentence grouping databases that are pre-established, and compare the relevant words with the word functions to determine the data extraction grammar.

3. The business intelligence system based on AI according to claim 2, wherein the AI analysis module is further configured to extract data forms, fields, schemas from the multiple feature databases, and create the word functions by cross-dimensional integration and depth feature extraction.

4. The business intelligence system based on AI according to claim 1, wherein the AI analysis module is further configured to classify the multiple relevant words that are associated.

5. The business intelligence system based on AI according to claim 1, wherein the AI analysis module is further configured to feed back the multiple relevant words that are associated to the user.

6. The business intelligence system based on AI according to claim 1, wherein the feature extraction module comprises a virtual data set, a data connection module for data connection between multiple database tables, a data tagging module for tagging data, and a feature extraction unit.

7. The business intelligence system based on AI according to claim 1, wherein the data manager is configured to perform integration, grouping, disassembly, prediction, association, and tagging to the multiple feature data.

8. The business intelligence system based on AI according to claim 1, wherein the data manager comprises a data cleaning module for checking and correcting the multiple feature data and removing repeated data, an index module for indexing the multiple feature data according to predetermined rules, and an ETL processing module for performing ETL process to the multiple feature data.

9. The business intelligence system based on AI according to claim 1, further comprising a user interface adapted for allowing the user to input the natural language and present at least one of charts, text and data.

10. The business intelligence system based on AI according to claim 1, further comprising a retraining module connected with the AI analysis module and adapted for recording operation history of the user and updating the multiple feature databases.

11. An analysis method based on artificial intelligence (AI), comprising:
searching and analyzing relevant words in natural language of a user, and obtaining a data extraction grammar that is associated with the relevant words;
extracting multiple feature data from multiple databases corresponding to the data extraction grammar; and
processing and presenting the multiple feature data.

12. The analysis method based on AI according to claim 11, wherein said searching and analyzing relevant words in user's natural language, and obtaining a data extraction grammar that is associated with the relevant words comprises:
disassembling the natural language into multiple relevant words;
extracting multiple word functions from multiple grouping databases that are pre-established; and
comparing the relevant words with the word functions to determine the data extraction grammar.

13. The analysis method based on AI according to claim 12, wherein said extracting multiple word functions from multiple grouping databases that are pre-established comprises:
extracting data forms, fields, schemas from the multiple feature databases and creating the word functions by cross-dimensional integration and depth feature extraction.

14. The analysis method based on AI according to claim 12, further comprising classifying the relevant words that are associated.

15. The analysis method based on AI according to claim 12, further comprising feeding back the relevant words that are associated to the user.

16. The analysis method based on AI according to claim 11, wherein said extracting multiple feature data from multiple databases corresponding to the data extraction grammar comprises:
establishing a virtual data set;
establishing multiple database tables for data connection;
tagging different data; and
extracting the feature data.

17. The analysis method based on AI according to claim 11, wherein said processing the multiple feature data comprises performing integration, grouping, disassembly, prediction, association, tagging, and/or translation.

18. The analysis method based on AI according to claim 11, wherein said processing the multiple feature data comprises:
checking and correcting the multiple feature data and removing repeated data;
indexing the multiple feature data according to predetermined rules; and
performing ETL process to the multiple feature data.

19. The analysis method based on AI according to claim 11, wherein said presenting the multiple feature data comprises: presenting at least one of charts, text and data according to user habits and data attributes.

20. The analysis method based on AI according to claim 11, further comprising recording operation history of the user and updating the multiple feature databases.
